(19) United States
(12) Patent Application Publication
(10) Pub. No.: US 2018/0120448 A1
(43) Pub. Date: May 3, 2018

(54) RADIATION MEASURING DEVICE

(71) Applicant: Hitachi, Ltd., Tokyo (JP)

(72) Inventors: Toshiro OBATA, Tokyo (JP); Akihito YAMAGUCHI, Tokyo (JP); Toru KATO, Tokyo (JP)

(73) Assignee: Hitachi, Ltd., Tokyo (JP)

(21) Appl. No.: 15/561,881

(22) PCT Filed: Oct. 8, 2015
(86) PCT No.: PCT/JP2015/078673

§ 371 Date: Sep. 26, 2017

(30) Foreign Application Priority Data
Mar. 27, 2015 (JP) 2015-066502

(51) Int. Cl. G01T 1/16

(52) U.S. Cl. CPC G01T 1/16

(57) ABSTRACT

A radiation measurement value (instantaneous measurement value) expressed by a digital value is displayed in a numeral display area of a display unit of a survey meter. A current value marker that moves in a sliding manner in the horizontal direction in accordance with the radiation measurement value is displayed in a marker display area. A history marker is displayed accompanying that current value marker. The history marker is a marker that shows the direction of change (increasing direction, decreasing direction) and extent of change of the measurement value from the past until now, and is displayed on one of one side and the other side, or both, of the current value marker. The length of the history marker shows the amount of change of the measurement value within a fixed time in the past.

### TECHNICAL FIELD

The present disclosure relates to a radiation measuring device, in particular, to a technique for displaying a measured radiation value.

### BACKGROUND

As radiation measuring devices, survey meters, body surface monitors, and monitoring posts are well known. Such a radiation measuring device may include a radiation detector that detects radiation, and a body unit including a display for displaying measured radiation values (refer to Patent Literature 1). As a technique for displaying measured values, an analog meter indicating an instantaneous measured value by a needle is used. In an analog meter, a needle moves over a scale in accordance with a measured value such that the movement of the needle enables sensing of the fluctuation in the measured value. For example, observation of the deflection width of the needle enables sensing of whether the amount of radiation is stable.

### CITATION LIST

### Patent Literature

Patent Literature 1: JP 2014-153306A

### SUMMARY

### Technical Problem

As a system for displaying a measured value, there may be used a digital display system which expresses an instantaneous measured value by a digital value. In this case, it is impossible to sense a change in a measured value as in an analog display system. Specifically, in an analog display system, it is relatively easy to sense the magnitude of a change in a measured value by observing the movement of a needle (deflection width), while, in a digital display system in which a value itself is displayed, it is impossible to sense such a change.

An object of the present disclosure is to enable easy recognition of a change in a measured radiation value in a radiation measuring device.

### Solution to Problem

A radiation measuring device according to the present disclosure includes a radiation detector that detects radiation; and a display controller that performs a control to display, on a display unit, a current value marker that moves in a sliding manner in accordance with a current measured value based on a detected signal from the radiation detector, and a history marker that represents the direction and the degree of change of a measured value from the past to the present. The history marker is associated with the current value marker.

According to the above configuration, the direction and the degree of change of the measured value from the past to the present are indicated. The direction of change indicates an increasing direction or a decreasing direction of the measured value. The degree of change corresponds to, for example, the amount of change in the measured value. By observing the history marker, a measurer can recognize the direction of change of the measured value (the measured value is either increasing or decreasing) and the degree of change (the amount of increase or decrease). In this way, sensing of the change in the measured value can be realized. For example, sensing of whether the measured value is stable can be realized.

It is preferable that the display controller performs a control to display the history marker on either or both of one side and the other side of the current value marker in accordance with the direction of change of the measured value, thereby realizing sensing of the direction of change of the measured value.

It is preferable that when a current measured value increases with respect to a past measured value, the display controller performs a control to display the history marker in an area on a smaller measured value side than the current value marker; whereas when a current measured value decreases with respect to a past measured value, the display controller performs a control to display the history marker in an area on a larger measured value side than the current value marker. In this way, sensing of whether the measured value is increasing or decreasing can be realized.

It is preferable that when the measured value fluctuates up and down, the display controller performs a control to display the history marker in both areas on the smaller measured value side and the larger measured value side than the current value marker. In this way, sensing that the measured value is unstable can be realized. An unstable state indicates, for example, that the measured value is in a fluctuating state.

Preferably, a gap is formed between a display position of the current value marker and a display position of the history marker. In this way, the visibility of the current marker can be enhanced.

Preferably, the display controller performs a control to display the history maker on the display unit when a difference between a past measured value and a current measured value is equal to or higher than a predetermined value.

Preferably, the current value marker is a maker having a line shape extending in a vertical direction, and the history marker includes two or more horizontal lines arranged in a vertical direction.

### Advantageous Effects of Invention

According to the present disclosure, an easy recognition of a change in a measured radiation value is enabled.

### BRIEF DESCRIPTION OF DRAWINGS

FIG. 1 is a perspective diagram of a radiation measuring device according to an embodiment of the present disclosure;

FIG. 2 is a block diagram showing the configuration of the radiation measuring device according to the embodiment;

FIG. 3 is a display example of a display unit;

FIG. 4 is a graph showing the amount of radiation at time points;

FIG. 5 is a diagram showing a current value marker and a history marker;

FIG. 6 is a diagram showing a current value marker and a history marker;

FIG. 7 is a diagram showing a current value marker and history markers;

FIG. 8 is a diagram showing a relationship between the amount of radiation and display types of the markers;

FIG. 9 is a diagram showing a current value marker and history markers;

FIG. 10A is a diagram showing a display example when a range is changed;

FIG. 10B is a diagram showing a display example when a range is changed;

FIG. 11A is a diagram showing a display example when a range is changed;

FIG. 11B is a diagram showing a display example when a range is changed;

FIG. 12 is a diagram showing display examples of measured values and markers;

FIG. 13 is a diagram showing display examples of measured values and markers;

FIG. 14 is a diagram showing display examples of measured values and markers;

FIG. 15 is a diagram showing display examples of measured values and markers; and

FIG. 16 is a diagram showing a marker according to a variation of the embodiment.

### DESCRIPTION OF EMBODIMENTS

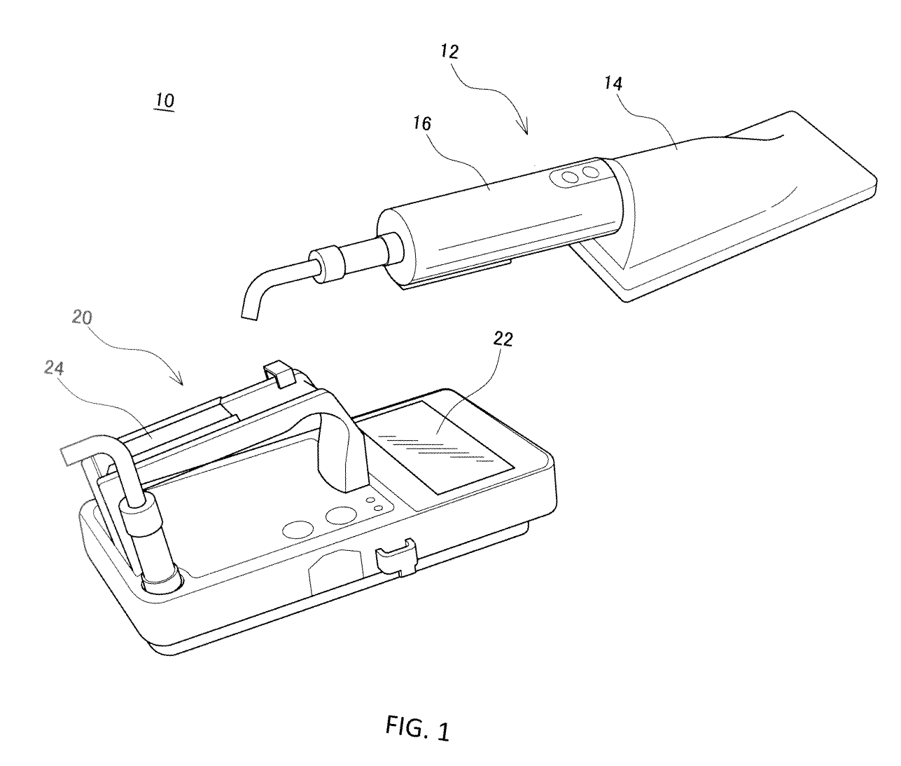

FIG. 1 shows an example of a radiation measuring device according to an embodiment of the present disclosure. A survey meter 10 which is a radiation measuring device includes a detecting unit (detecting probe) 12 and a body unit 20. The detecting unit 12 and the body unit 20 are connected to each other via a wired or wireless communication system.

The detecting unit 12 includes a probe head 14 for detecting radiation, and a grip 16 which is grasped by a measurer. The body unit 20 includes a touch panel monitor (display panel) 22, a coupling portion 24, and various operation buttons. The touch panel monitor 22 displays a measured radiation value. The touch panel monitor 22 includes, for example, a liquid crystal display and a touch sensor. The touch panel monitor 22 functions as a user interface which is used as both an input unit and a display unit. A measurer may perform various inputs by using icons which are displayed on the touch panel monitor 22. Of course, the body unit 20 may be provided with a display unit without a touch sensor, in place of the touch panel monitor 22. The detecting unit 12 and the body unit 20 can be united by coupling these via the coupling portion 24.

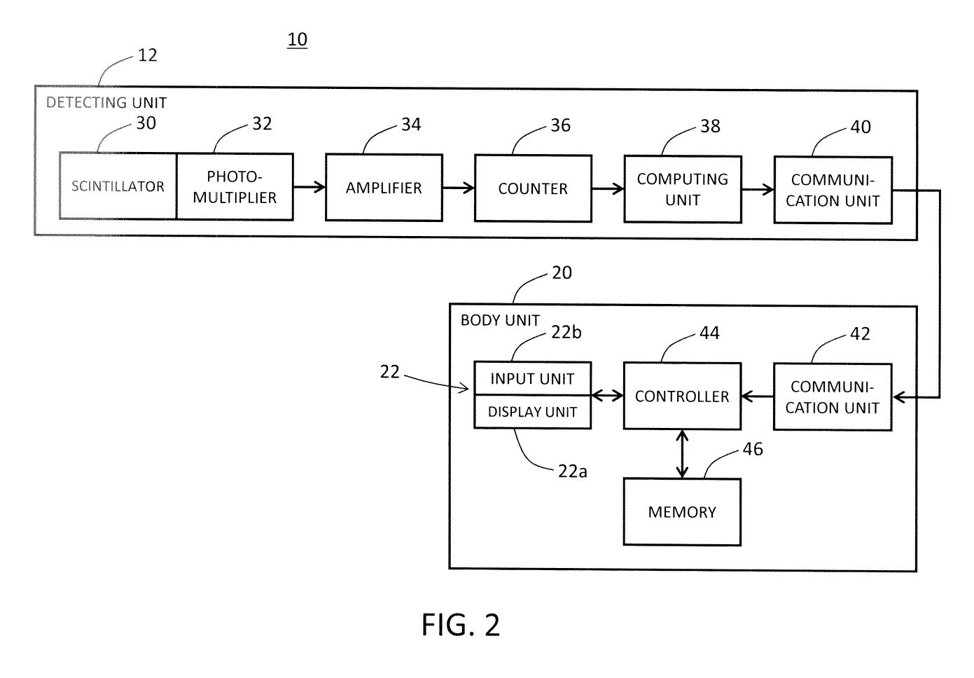

FIG. 2 shows a block diagram of the survey meter 10. The detecting unit 12 has a built-in detector such as a scintillation counter or a Geiger-Müller (G-M) tube. FIG. 2 shows a configuration example of the scintillation counter. Radiation is detected by a scintillator 30 and a photomultiplier 32. Detected signals are amplified by an amplifier 34. A waveform shaping process and a wave height discrimination process are performed to count the detected number of units of radiation by a counter 36. Then, a computing unit 38 calculates a radiation count rate (counts per minute (CPM) or counts per second (CPS)). Measured data, which is the calculation result, is sent to the body unit 20 via a communication unit 40. The detecting unit 12 includes, for example, a CPU and a memory such that the functions of the counter 36 and the computing unit 38 can be achieved, for example, by executing a program by the CPU.

The body unit 20 includes the touch panel monitor 22 which functions as a user interface, a communication unit 42, a controller 44, and a memory 46. A display unit 22a for displaying a measured value or the like and an input unit 22b for operating the survey meter 10 are united on the touch panel monitor 22. Of course, a touch panel monitor can be avoided such that the display unit 22a and the input unit 22b are separately provided. The communication unit 42 receives measured value data from the detecting unit 12. The controller 44 controls operations of the body unit 20. For example, the controller 44 displays measured values on the touch panel monitor 22 in a predetermined display format. In the present embodiment, the controller 44 displays, on the touch panel monitor 22, a measured value expressed by a digital value. The controller 44 further displays, on the touch panel monitor 22, a current value marker which moves in a sliding manner in accordance with a current measured value (instantaneous measured value), and a history marker which shows a relationship between a past measured value and the current measured value. The historical marker represents the direction and the degree of change of a measured value from the past to the present. These markers are described in detail below. The controller 44 may display images of various operation buttons on the touch panel monitor 22. In this case, a measurer can provide a command for executing various processes by performing a touch operation on the operation buttons displayed on the touch panel monitor 22. The memory 46 stores measured value data sent from the detecting unit 12. The body unit 20 includes, for example, a CPU. The functions of the controller 44 can be achieved, for example, by executing a program by the CPU.

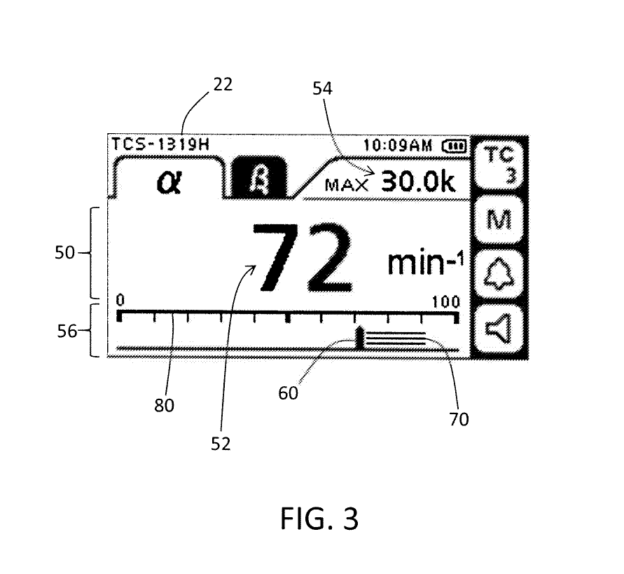

The current value marker and the history marker which are displayed on the touch panel monitor 22 are described below. FIG. 3 shows a display example of the touch panel monitor 22. The display area of the touch panel monitor 22 includes a value display area 50 and a marker display area 56.

The controller 44 displays, in the value display area 50, a measured radiation value expressed by a digital value. In the example shown in FIG. 3, because a measurer has performed a touch operation on an operation button [α] to provide a command to display about an alpha line (α line), an instantaneous measured value 52 and a maximum value 54 of the alpha line are displayed. When the measurer performs a touch operation on an operation button [β], an instantaneous measured value and a maximum value of a beta line (β line) are displayed. A measured value of a gamma line (γ line) may also be displayed by a digital value.

The controller 44 displays, in the marker display area 56, a current value marker 60 indicating a current measured value (instantaneous measured value), a history marker 70 indicating a relationship between a past measured value and the current measured value, and an image of a scale 80.

The scale 80 shows the amount of radiation. As an example, the scale 80 extends in the horizontal direction in the marker display area 56. In the example shown in FIG. 3, a value is smaller when closer to the left end, whereas a value is larger when closer to the right end. As an example, the scale 80 shows a range from 0 to 100 (min⁻¹). This range of the scale 80 is variable in accordance with a measured value. The controller 44 displays the current value marker 60 at a display position corresponding to the instantaneous measured value along the scale 80. In the example shown in FIG. 3, as the instantaneous measured value is 72, the current value marker 60 is displayed at the display position corresponding to this value. When the instantaneous measured value changes, the display position of the current value marker 60 shifts to the left or right in accordance with the change. The current value marker 60 moves in a sliding manner in the horizontal direction along the scale 80 in accordance with the instantaneous measured value. The current value marker 60 has a line shape (bar or needle shape) extending in the vertical (up and down) direction. It should be noted that this shape is merely one example. The current value marker 60 may have a circular or dot shape.

The history marker 70 is a marker which appears like a windsock originating at the current value marker 60. The history marker 70 is formed with linear markers (horizontal lines) extending horizontally and arranged in the vertical direction. In the example shown in FIG. 3, the history marker 70 is formed, for example, with three linear markers. It should be noted that the number of lines is merely an example. The history marker 70 may be formed with one or more markers. Further, the history marker 70 may be a curved marker. The history marker 70 represents the direction and the degree of change of the measured value from the past to the present. The history marker 70 is displayed on either or both sides of the current value marker 60 in accordance with the direction of change in the measured value. For example, when the current value (instantaneous measured value) increases with respect to a past measured value, the history marker 70 is displayed on the smaller measured value side than the current value marker 60. In the example shown in FIG. 3, a value becomes smaller when the point is closer to the left end, whereas a value becomes larger when the point is closer to the right end. Thus, when the measured value increases, the history marker 70 is displayed in the left area of the current value marker 60. In contrast, when the current measured value (instantaneous measured value) decreases with respect to a past measured value, the history marker 70 is displayed on the larger measured value side than the current value marker 60. Specifically, the history marker 70 is displayed in the right area of the current value marker 60. In the example shown in FIG. 3, because the history marker 70 is displayed on the right area of the current value marker 60, it is indicated that the measured value has decreased. The length of the history marker 70 represents the amount of change in the measured value for a predetermined time period in the past. Specifically, the length of the history marker 70 represents the difference between a past measured value and a current measured value (instantaneous measured value). The longer the length, the larger the amount of change. The length of the history marker 70, therefore, indicates the speed of change in the measured value (the amount of change in the measured value in a unit time). The longer the length, the higher the speed of change (increasing speed or decreasing speed). Specific display processes of the history marker 70 are described further below.

The touch panel monitor 22 displays various operation buttons such as an operation button (TC) and another operation button (M). The operation button (TC) switches a time constant. The time constant is switched when a measurer performs a touch operation on the operation button (TC). The operation button (M) stores measured data in a memory. Data is stored into a memory when the measurer performs a touch operation on the operation button (M).

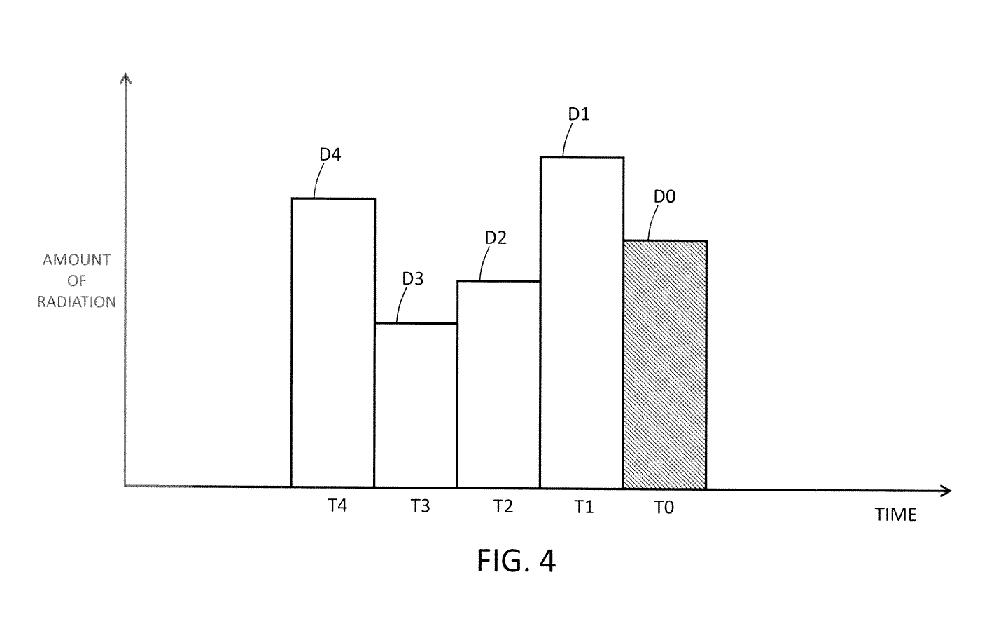

With reference to FIGS. 4 to 8, specific display processes of the history marker are described below. FIG. 4 schematically shows a bar graph of measured amount of radiation. The horizontal axis represents time and the vertical axis represents a measured value (the amount of radiation). In the survey meter 10, the radiation is measured at a predetermined interval to obtain a measured value at the predetermined time interval. The measured value data at time points is stored in the memory 46 in the body unit 20. Measured values D0 to D4 represent measured values obtained at the time intervals. Time point T0 represents the current time point, whereas time points T1 to T4 represent time points in the past. A time point on the farther left represents an older time point in the past. In the example shown in FIG. 4, among the time points T0 to T4, the time point T4 is the oldest. Time proceeds in the order of time points T4, T3, T2, T1, and T0. The measured value D0 is a measured value measured at the current time point T0. The measured values D1 to D4 are measured values obtained respectively at the past time points T1 to T4. Among the measured values D0 to D4, the measured value D4 is obtained at the oldest time point. As an example, the predetermined time interval is 0.5 sec. The amount of radiation is measured to obtain a measured value every 0.5 seconds. Thus, the measured values D0 to D4 represent measured values obtained at 0.5 sec intervals. More specifically, the measured value D1 is a value obtained 0.5 sec earlier than the measured value D0; the measured value D2 is a value obtained 0.5 sec earlier than the measured value D1; the measured value D3 is a value obtained 0.5 sec earlier than the measured value D2; and the measured value D4 is a value obtained 0.5 sec earlier than the measured value D3.

In the present embodiment, the historical marker is formed by using measured values in the past two seconds as an example. In the example shown in FIG. 4, the history marker is formed by using the measured values D1 to D4. The data of the measured values for past two seconds is stored in the memory 46. The controller 44 uses the data to form the history marker. Of course, the measurement time interval may be a time interval other than 0.5 sec and the used data may be for a time period other than the past 2 seconds.

In the marker display area 56, the controller 44 displays a stripe-shaped marker connecting between the display position of the current value marker indicating the measured value D0 and the display positions of the past current value markers indicating past measured values. This stripe-shaped marker corresponds to the history marker. The controller 44 actually does not display the markers indicating the past measured values but displays the current value marker indicating the current measured value D0 and the history marker.

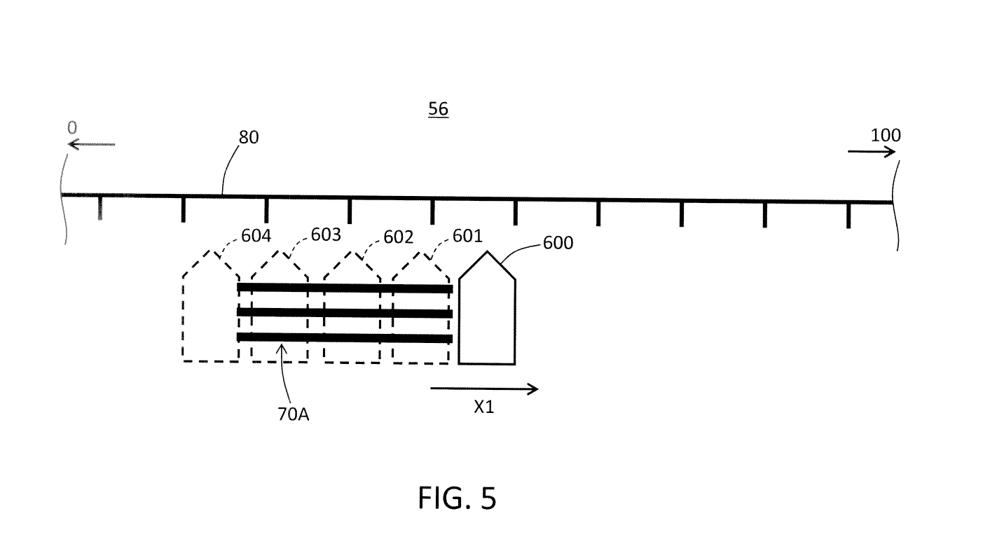

With reference to FIGS. 5 to 8, the display processes of the history marker are described in detail below.

FIG. 5 shows a part of the marker display area 56. It is assumed here that the measured value monotonically increases. In such a case, the current value markers are displayed in a manner moving to the right side of the scale 80 (the direction of arrow X1). A current value marker 600 is displayed at the display position corresponding to the measured value D0 at the current time point T0. Markers 601, 602, 603, and 604 in broken lines are past current value markers indicating measured values in the past. These markers are not displayed at the current time point T0. The marker 601 shows the measured value D1 at the time point T1; the marker 602 shows the measured value D2 at the time point T2; the marker 603 shows the measured value D3 at the time point T3; and the marker 604 shows the measured value D4 at the time point T4. Among the time points T0 to T4, the time point T4 is the oldest time point. Time proceeds in the order of the time points T4, T3, T2, T1, and T0. It is further assumed that the measured values D0 to D4 satisfy the relationship of D0>D1>D2>D3>D4.

The controller 44 forms a stripe-shaped marker connecting between the current value marker 600 and the markers 601 to 604. When the measured value monotonically increases, a stripe-shaped marker connecting between the marker 604 indicating the smallest value (measured value D4) and the current value marker 600 is formed as a history marker 70A as a result. The current value marker 600 and the history marker 70A are displayed in the marker display area 56. Because the measured value monotonically increases, the history marker 70A is displayed on the left side of the current value marker 600. The length of the history marker 70A corresponds to the difference between the current measured value D0 and the smallest measured value D4. By observing the display position of the history marker 70A, the measurer can sense that the measured value has an increasing tendency. By observing the length of the history marker 70A, the measurer can sense the amount of change (increased amount) of the measured value in a predetermined time period in the past. The longer the length, the larger the amount of increase, indicating an unstable amount of radiation.

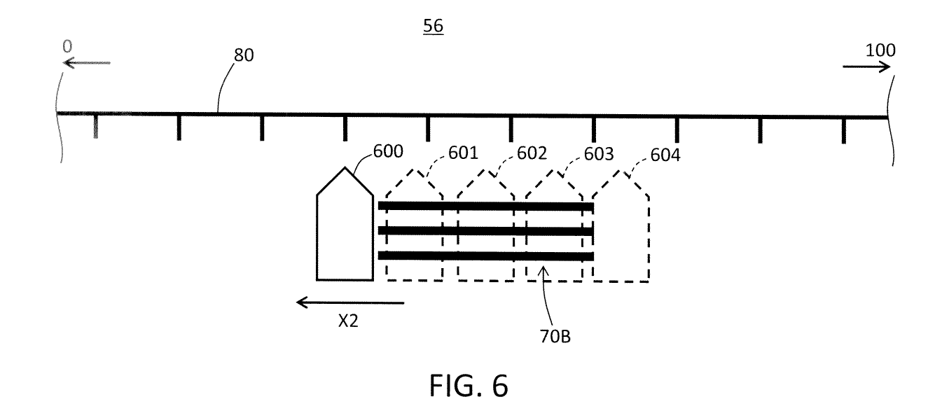

With reference to FIG. 6, another example is described. FIG. 6 shows a part of the marker display area 56. It is assumed here that the measured value monotonically decreases. In such a case, the current value markers are displayed in a manner moving to the left side of the scale 80 (direction of arrow X2). The current value marker 600 is displayed at the display position corresponding to the measured value D0 at the current time point T0. Similarly to the example in FIG. 5, the markers 601 to 604 are past current value markers indicating measured values in the past. These markers are not displayed at the current time point T0. In the example shown in FIG. 6, it is assumed that the measured values D0 to D4 satisfy the relationship of D4>D3>D2>D1>D0.

The controller 44 forms a stripe-shaped marker connecting between the current value marker 600 and the markers 601 to 604. When the measured value monotonically decreases, a stripe-shaped marker connecting between the marker 604 indicating the largest value (measured value D4) and the current value marker 600 is formed as a history marker 70B as a result. The current value marker 600 and the history marker 70B are displayed in the marker display area 56. Because the measured values monotonically decrease, the history marker 70B is displayed on the right side of the current value marker 600. The length of the history marker 70B corresponds to the difference between the current measured value D0 and the largest measured value D4. By observing the display position of the history marker 70B, the measurer can sense that the measured value has a decreasing tendency. Further, by observing the length of the history marker 70B, the measurer can sense the amount of change (decreased amount) of the measured value in a predetermined time period in the past. The longer the length, the larger the decreased amount, indicating an unstable amount of radiation.

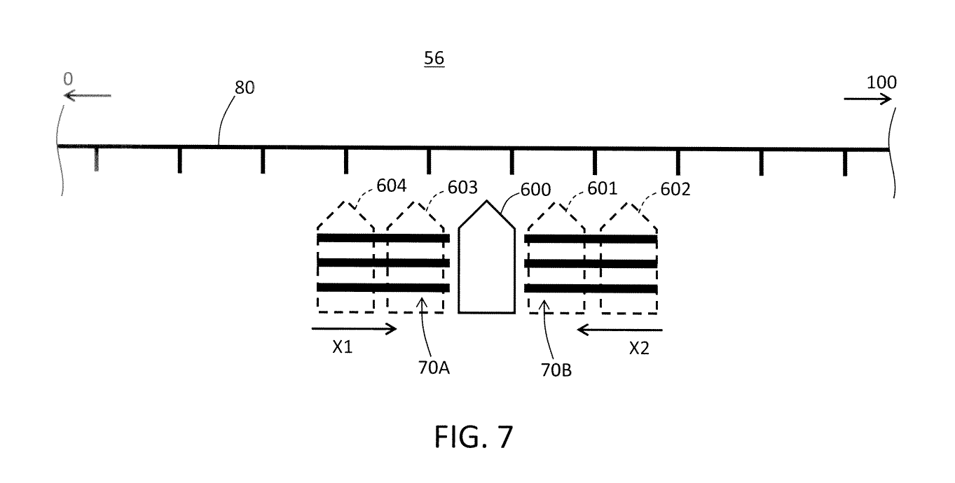

With reference to FIG. 7, yet another example is described. FIG. 7 shows a part of the marker display area 56. It is assumed here that the measured value fluctuates up and down. In other words, the measured value increases and decreases. The current value marker 600 is displayed at the display position corresponding to the measured value D0 at the current time point T0. Similarly to the example shown in FIG. 5, the markers 601 to 604 are past current value markers indicating measured values in the past. These markers are not displayed at the current time point T0. In the example shown in FIG. 7, it is assumed that the measured values D0 to D4 satisfy the relationship of D2>D1>D0>D3>D4. Thus, the measured value once increases and then decreases. In such a case, the current value markers are displayed in a manner moving once to the right side of the scale 80 (the direction of arrow X1), and then to the left (the direction of arrow X2).

The controller 44 forms stripe-shaped markers connecting between the current value marker 600 and the markers 601 to 604. When the measured value fluctuates up and down, a stripe-shaped marker connecting between the marker 604 indicating the smallest value (measured value D4) and the current value marker 600 is formed as a history marker 70A, and another stripe-shaped marker connecting between the marker 602 indicating the largest value (measured value D2) and the current value marker 600 is formed as a history marker 70B. The current value marker 600 and the history markers 70A and 70B are displayed in the marker display area 56. Because the measured value fluctuates up and down, the historical marker is displayed on both sides of the current value marker 600. The history marker 70A which indicates an increase in the measured value is displayed on the left side of the current value marker 600, whereas the history marker 70B which indicates a decrease in the measured value is displayed on the right side of the current value marker 600. The length of the history marker 70A corresponds to the difference between the current measured value D0 and the smallest value (measured value D4). The length of the history marker 70B corresponds to the difference between the current measured value D0 and the largest value (measured value D2). By observing the length of the history markers 70A and 70B, the measurer can sense that the measured value fluctuates up and down (increases and decreases). Further, by observing the lengths of the history markers 70A and 70B, the measurer can sense the amount of change (increased amount and decreased amount) of the measured value in a predetermined time period in the past. The longer the length, the larger the increased or decreased amount, indicating an unstable amount of radiation.

It may be the case that the controller 44 does not display the history marker when the difference between the instantaneous measured value (current measured value) and a past measured value is equal to or lower than a predetermined value. For example, when the difference between the instantaneous measured value and the past measured value is minimum, the history marker is not displayed. This predetermined value may be changed to any value by the measurer.

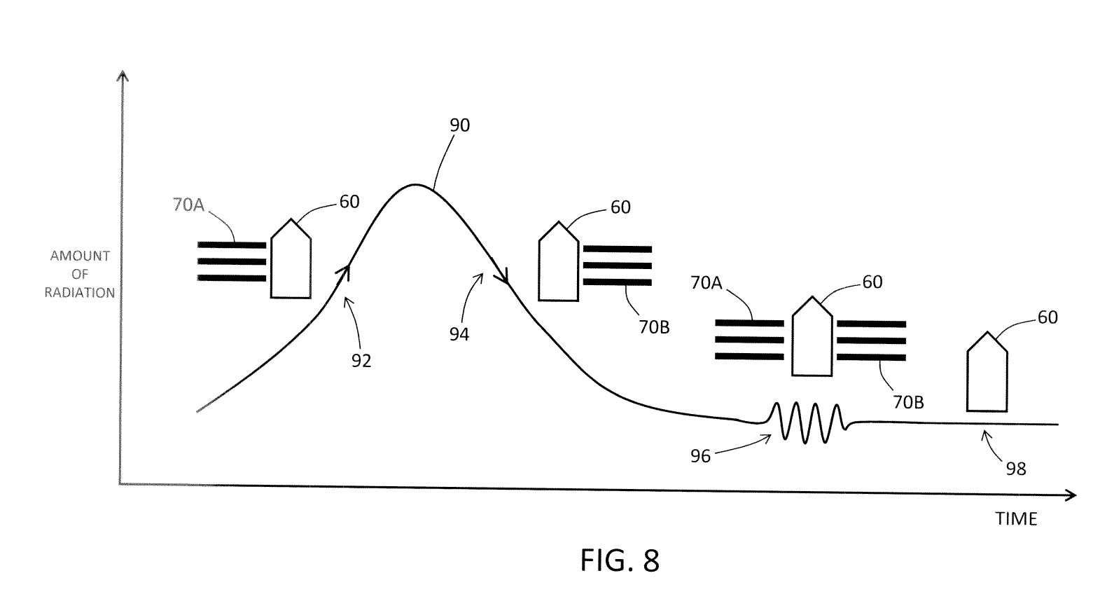

FIG. 8 shows a relationship between the amount of radiation and the display patterns of the markers. The horizontal axis represents time and the vertical axis represents the amount of radiation (instantaneous measured value). The graph line represented by Reference Numeral 90 indicates how the measured value changes over time. The measured value increases over time as shown by an arrow 92, and then decreases over time as shown by an arrow 94. Subsequently, the measured value fluctuates as shown by an arrow 96, and then becomes almost constant as shown by an arrow 98. When the measured value has such characteristics, the history marker 70A is displayed on the left side of the current value marker 60 in the measured value increasing section (section shown by the arrow 92), and the history marker 70B is displayed on the right side of the current value marker 60 in the measured value decreasing section (section shown by the arrow 94). In the section where the measured value fluctuates (section shown by the arrow 96), the history markers (history markers 70A and 70B) are respectively placed on both sides of the current value marker 60. In the section where the measured value is almost constant (section shown by the arrow 98), because the fluctuation of the measured value is none or minimum, the history markers 70A and 70B are not displayed, while the current value marker 60 alone is displayed. As described above, the display position of the history marker is changed in accordance with the direction of change of the measured value from the past to the present. The length of the history markers 70A and 70B is changed in accordance with the amount of change in the amount of radiation in a predetermined time period in the past.

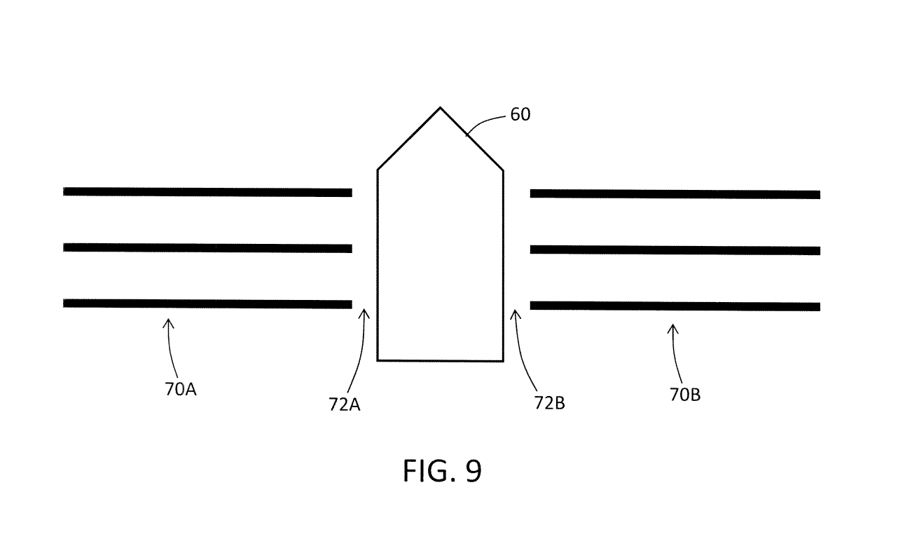

Next, with reference to FIG. 9, the relationships between the display position of the current value marker and the display positions of the history markers are described. A gap (space) is provided between the current value marker and the history markers. Specifically, a gap 72A of the predetermined number of pixels (dots) is provided between the history marker 70A displayed on the left and the current value marker 60, whereas a gap 72B of the predetermined number of pixels (dots) is provided between the history marker 70B displayed on the right and the current value marker 60. The gaps 72A and 72B are blank areas. For example, the gaps 72A and 72B of one pixel are formed. Of course, the gaps 72A and 72B of two or more pixels may be formed. By providing the gaps 72A and 72B to separately display the current value marker 60 and the history markers 70A and 70B, the current value marker 60 becomes more visible, enhancing the visibility of the entire marks. Of course, the current value marker 60 and the history markers 70A and 70B may be unitedly displayed.

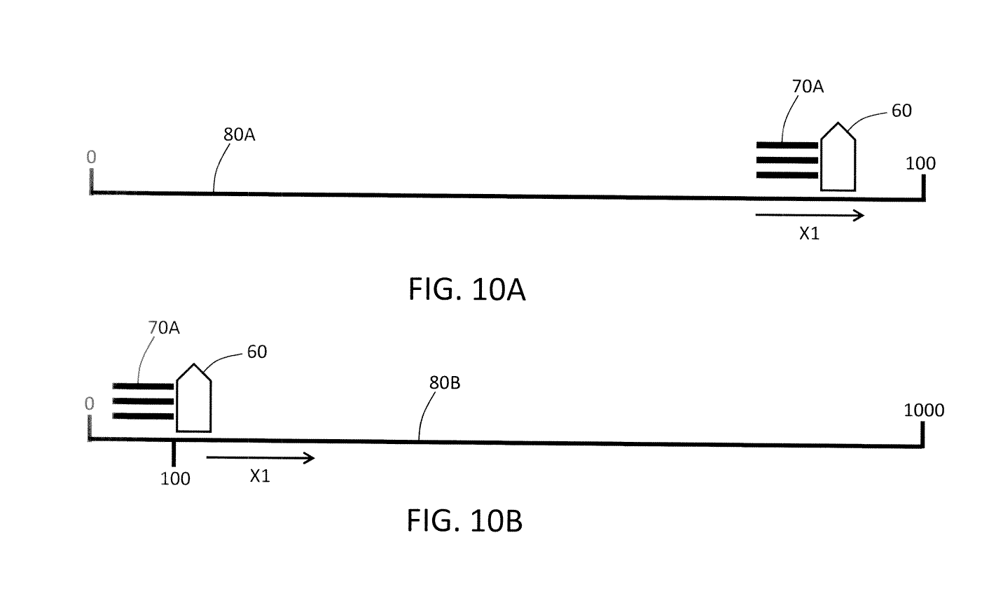

Next, display examples of the markers when the range of the scale 80 in the marker display area 56 changes are described. In the present embodiment, the survey meter 10 is provided with an auto-range function to automatically switch the range of the scale 80 in accordance with the measured value. FIGS. 10A and 10B show display examples when the measured value increases. A scale 80A shown in FIG. 10A has a range for a measured value of 0 to 100. A scale 80B shown in FIG. 10B has a range for a measured value of 0 to 1,000. The scale 80A is automatically switched to the scale 80B when the measured value is equal to or higher than a predetermined value. The switch of range is performed by the controller 44. For example, when the measured value is 90% or more of the maximum value of the range, the range is switched. Specifically, when the measured value is lower than 90, the scale 80A is displayed, whereas when the measured value reaches 90 or more, the range is switched from the scale 80A to the scale 80B. As described above, an appropriate hysteresis is provided for switching the range. A historical marker is displayed also when the range is switched. When the measured value monotonically increases, the history marker 70A having a length corresponding to the amount of change in the measured value is displayed on the left side of the current value marker 60.

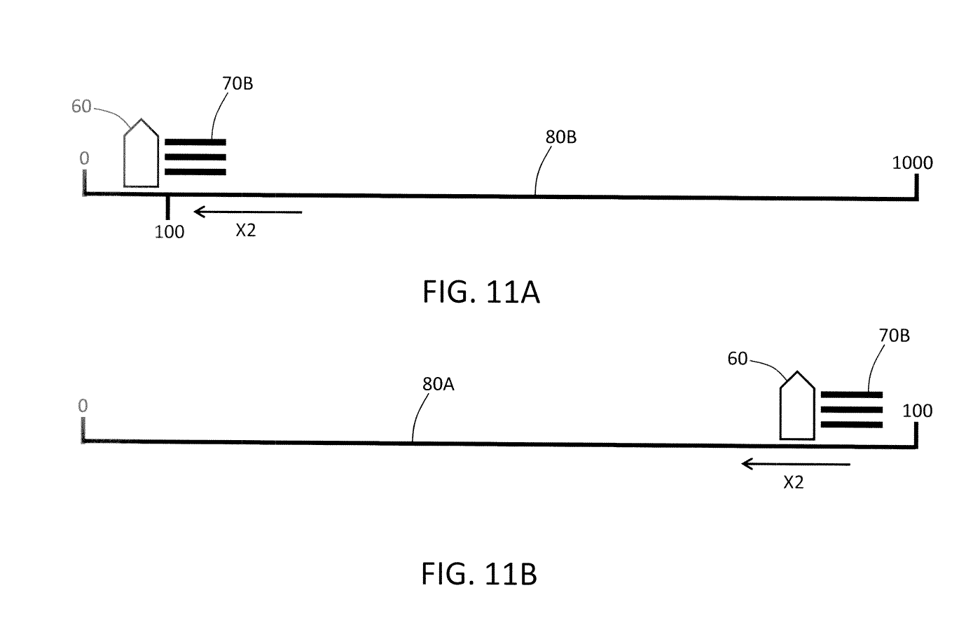

FIGS. 11A and 11B show display examples when the measured value decreases. A scale 80B shown in FIG. 11A has a range for a measured value of 0 to 1,000. A scale 80A shown in FIG. 11B has a range for a measured value of 0 to 100. The scale 80B is automatically switched to the scale 80A when the measured value is lower than a predetermined value. The switch of range is performed by the controller 44. For example, when the measured value is lower than 9% of the maximum value of the range, the range is switched. Specifically, when the measured value is equal to 90 or more, the scale 80B is displayed, whereas when the measured value is lower than 90, the range is switched from the scale 80B to the scale 80A. As described above, an appropriate hysteresis is provided for switching the range. When the measured value monotonically decreases, the history marker 70B having a length corresponding to the amount of change in the measured value is displayed on the right side of the current value marker 60.

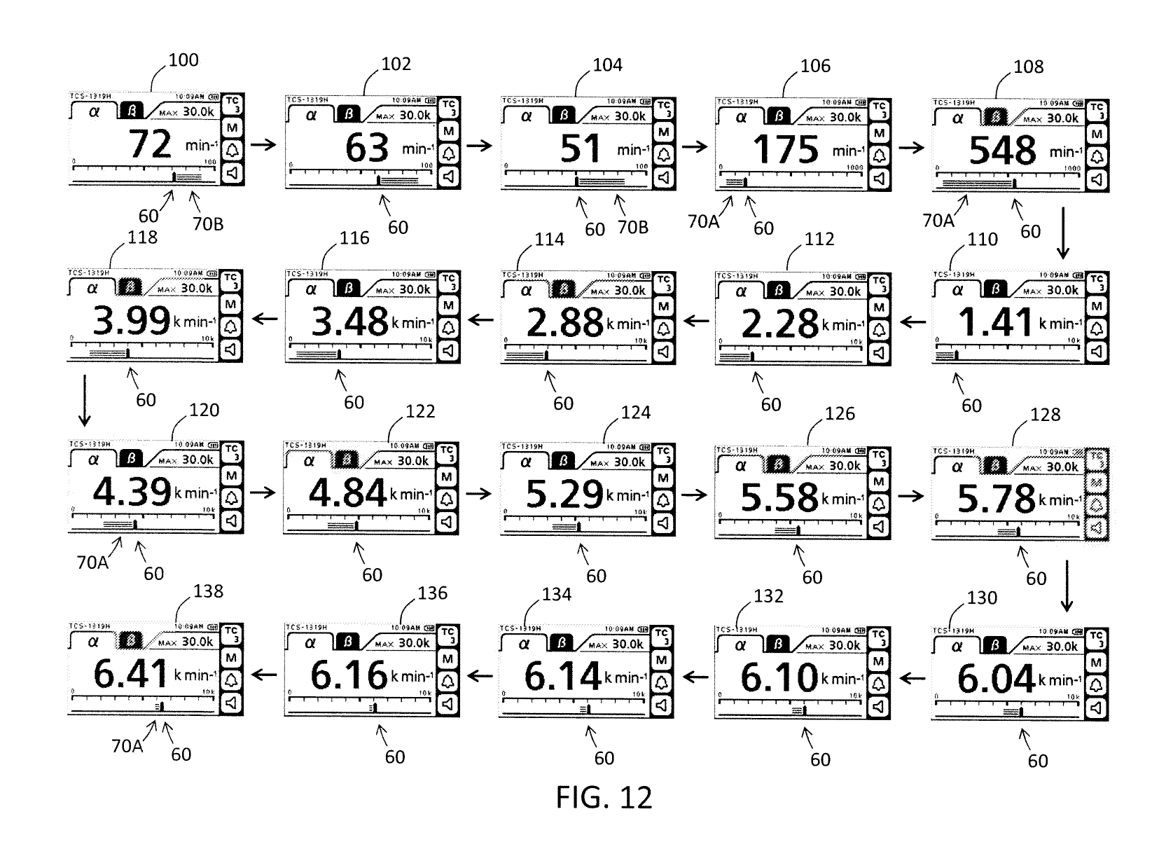

Next, with reference to FIGS. 12 to 15, display examples of the measurement values and the markers are described. FIGS. 12 to 15 show display examples of the instantaneous measured values and the markers (current value markers and history markers). These drawings show the instantaneous measured values and the markers in a time sequential order. A time period represented by Reference Numerals 100 to 230 is shown. It is assumed that time proceeds from Reference Numerals 100 to 230.

FIG. 12 shows the instantaneous measured values and the markers in a period represented by Reference Numerals 100 to 138. At the time point represented by Reference Numeral 100, the instantaneous measured value is 72 min⁻¹ and the range is 0 to 100. In the period represented by Reference Numerals 100 to 104, because the measured value decreases monotonically, the history marker 70B is displayed on the right side of the current value marker 60. This display position of the history marker 70B enables the measurer to sense that the measured value is monotonically decreasing. Further, the amount of change in the measured value in a predetermined time period in the past is indicted by the length of the history marker 70B. From the time point represented by Reference Numeral 100 to the time point represented by Reference Numeral 104, the length of the history marker 70B gradually increases. Thus, it can be recognized that the change speed of the measured value (the amount of change in the measured value for a unit time period) gradually accelerates. By observing the length and the change in the length, the measurer can sense the degree of the amount of change and the change speed of the measured value in a predetermined time period in the past.

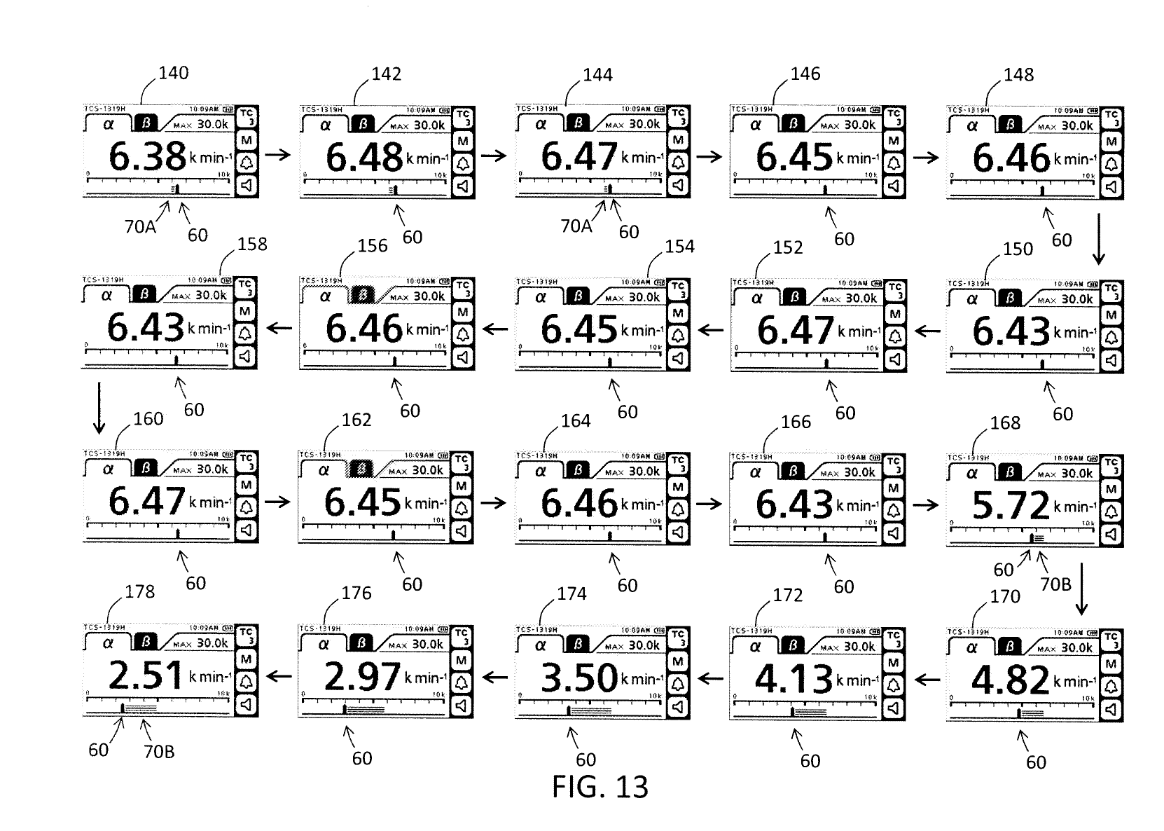

At the time point represented by Reference Numeral 106, because the measured value increases monotonically, the history marker 70A is displayed on the left side of the current value marker 60. Further, the range is changed to 0 to 1000. At the time point represented by Reference Numeral 108, the length of the history marker 70A rapidly increases. By observing this, the rapid increase in the measurement value can be sensed. In the time period represented by Reference Numerals 108 to 138, the measured value monotonically increases and the range is changed to 0 to 10k (10,000) during the period. After the time period represented by Reference Numeral 120, the length of the history marker 70A gradually decreases until the length becomes very short at the time point represented by Reference Numeral 138. Thus, after the time point represented by Reference Numeral 120, the change speed of the measured value gradually decreases until the change speed is very low at the time point represented by Reference Numeral 138. The subsequent measured values and the markers are shown in FIG. 13.

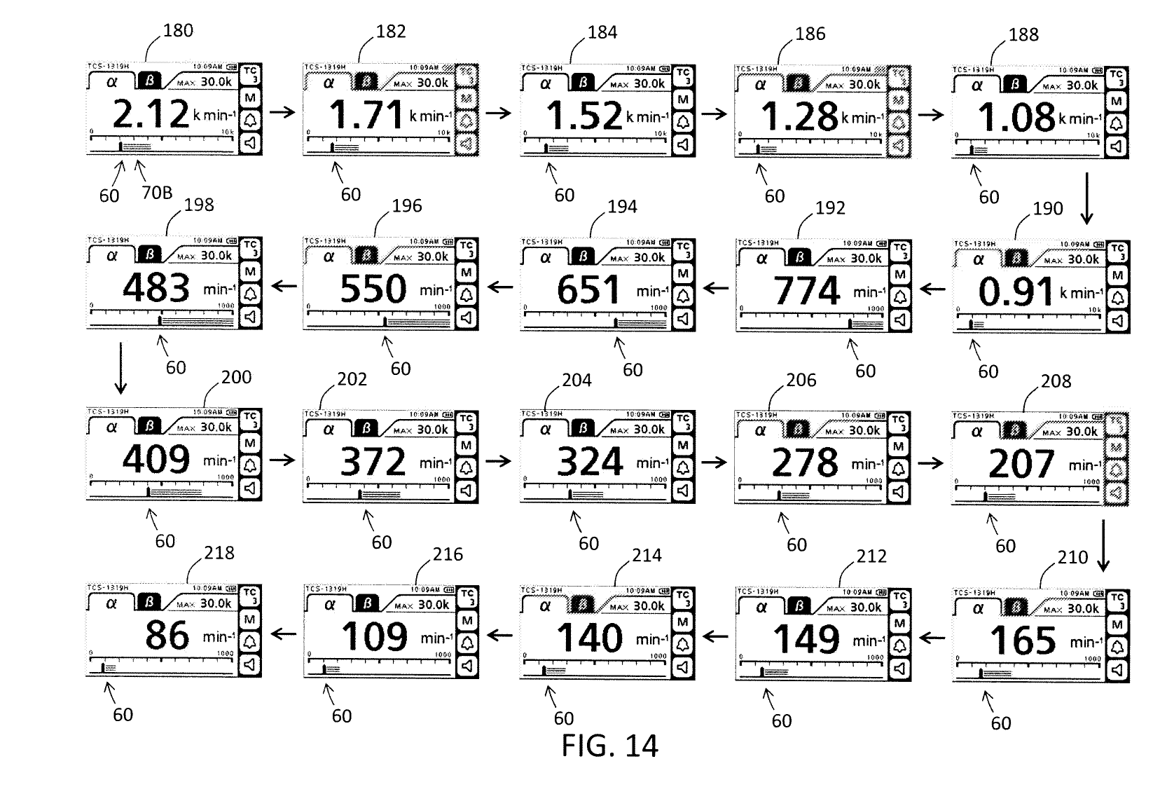

FIG. 13 shows the measured values and the markers in a time period represented by Reference Numerals 140 to 178. In the period represented by Reference Numerals 140 to 144, the history markers 70A having a very short length are displayed. Thus, in this time period, the change speed of the measured value is very low. Further, in the time period represented by Reference Numerals 146 to 166, the history markers 70A and 70B are not displayed. This indicates that, in this period, the amount of change in the measured value in a predetermined time period in the past is either below the predetermined value or zero. In other words, the amount of radiation is stable. The measured value obtained in such a period can be recognized as a value obtained when the amount of radiation is stable. By observing the markers in this time period, the measurer can sense that the amount of radiation is stable. In the time period represented by Reference Numerals 168 to 178, because the measured value monotonically decreases, the history marker 70B is displayed on the right side of the current value marker 60. The subsequent measured values and the markers are shown in FIG. 14.

FIG. 14 shows the measured values and the markers in the time period represented by Reference Numerals 180 to 218. In this time period, the measured value monotonically decreases. By observing the length of the history markers 70B, the change speed of the measured value can be recognized.

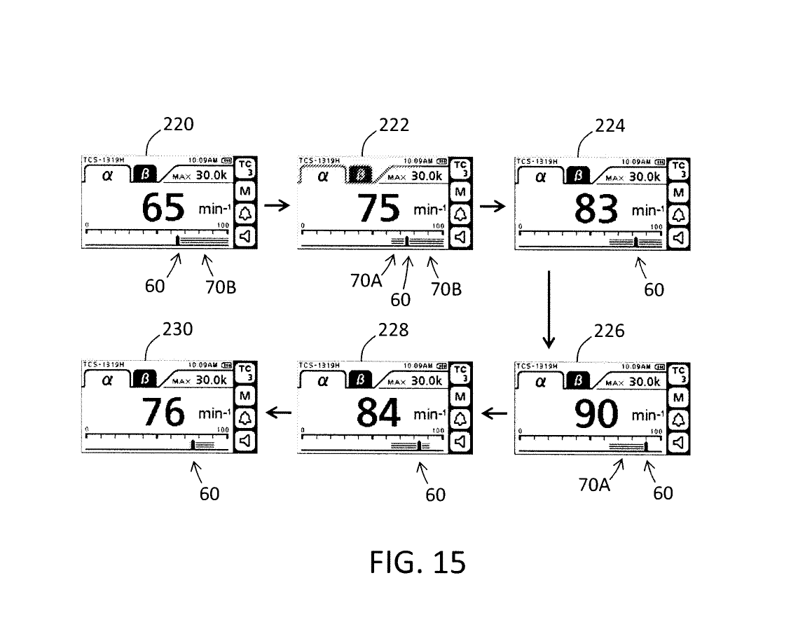

FIG. 15 shows the measured values and the markers in the time period represented by Reference Numerals 220 to 230. At the time point represented by Reference Numeral 220, the measured value decreases. At the time points represented by Reference Numerals 222 and 224, the history markers (history markers 70A and 70B) are displayed on respective sides of the current value marker 60. Thus, at the time points represented by the Reference Numerals 222 and 224, the measured value fluctuates. The measured value increases at the time point represented by Reference Numeral 226, fluctuates at the time point represented by Reference Numeral 228, and decreases at the time point represented by Reference Numeral 230. Thus, in the period represented by Reference Numerals 222 to 230, it is indicated that the amount of radiation is unstable. By observing the markers in these periods, the measurer can sense that the amount of radiation is unstable.

As described above, in the present embodiment, along with the current value marker 60, the associated history markers 70A and 70B are displayed. The measurer can sense the direction of change (increasing or decreasing) in the measured value by observing the display position of the history marker, and the amount of change and change speed of the measured value in a predetermined time period in the past by observing the length of the history marker. According to the present embodiment, the measurer can sense whether the measured amount of radiation is stable.

In the present embodiment, the history markers 70A and 70B are displayed in the direction opposite to the direction in which the measured value changes. When the measured value is monotonically increasing, the current value markers 60 are displayed to move in the right direction along the scale 80 with the history marker 70A displayed on the left side of the current value marker 60. When the measured value is monotonically decreasing, the current value markers 60 are displayed to move in the left direction along the scale 80 with the history marker 70B displayed on the right side of the current value marker 60. In this way, the history markers 70A and history marker 70B are displayed in the direction opposite to the movement direction of the current value marker 60. Because the history markers 70A and 70B express a sense of speed of the current value marker 60, the measurer can sense how the current value marker 60 is moving.

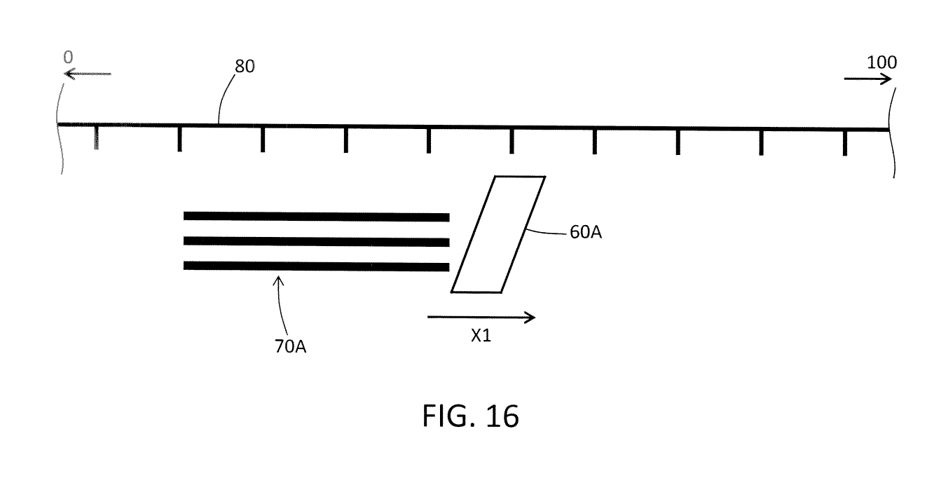

Next, with reference to FIG. 16, a marker according to a variation is described. In the above embodiment, the current value marker 60 has a shape extending vertically with respect to the scale 80. In this variation, the current value marker 60A has a shape inclined in the forward direction. In the example show in FIG. 16, because the measured value is monotonically increasing, the controller 44 displays a current value marker 60A in a manner inclining in the right direction. When the measured value is monotonically decreasing, the controller 44 displays the current value marker 60A in a manner inclining in the left direction. When the measured value periodically changes, or fluctuates, the controller 44 may display a not-inclined current value marker 60, or a current value marker 60 which inclines in the direction in accordance with the most recent one of the past measured values. By inclining the current value marker, a change in the measured value can be expressed by the current value marker depicting a better sense of speed.

### REFERENCE NUMERALS

10 survey meter, 12 detecting unit, 20 body unit, 22 touch panel monitor, 60, 600 current value marker, and 70, 70A, 70B history marker.

1. A radiation measuring device comprising:
a radiation detector that detects radiation; and
a display controller that performs a control to display, on a display unit,
a current value marker that moves in a sliding manner in accordance with a current measured value based on a detected signal from the radiation detector, and
a history marker that represents a direction and a degree of change of a measured value from past to present, the history marker being associated with the current value marker.

2. The radiation measuring device according to claim 1, wherein
the display controller performs a control to display the history marker on either or both of one side and the other side of the current value marker in accordance with the direction of change of the measured value.

3. The radiation measuring device according to claim 2, wherein
when a current measured value increases with respect to a past measured value, the display controller performs a control to display the history marker in an area on a smaller measured value side than the current value marker; whereas when a current measured value decreases with respect to a past measured value, the display controller performs a control to display the history marker in an area on a larger measured value side than the current value marker.

4. The radiation measuring device according to claim 2, wherein
when the measured value fluctuates up and down, the display controller performs a control to display the history marker in both areas on a smaller measured value side and a larger measured value side than the current value marker.

5. The radiation measuring device according to claim 1, wherein
a gap is formed between a display position of the current value marker and a display position of the history marker.

6. The radiation measuring device according to claim 1, wherein
the display controller performs a control to display the history marker on the display unit when a difference between a past measured value and a current measured value is equal to or higher than a predetermined value.

7. The radiation measuring device according to claim 1, wherein
the current value marker is a maker having a line shape extending in a vertical direction; and
the history marker comprises a plurality of horizontal lines arranged in a vertical direction.
